(19) United States
(12) Patent Application Publication
(10) Pub. No.: US 2026/0260785 A1
(43) Pub. Date: Sep. 3, 2026

(54) MULTICORE CABLE

(71) Applicant: Nissei Electric Co., Ltd., Hamamatsu-shi (JP)

(72) Inventors: Ken HASHIMOTO, Hamamatsu-shi (JP); Kenta NAKANO, Hamamatsu-shi (JP)

(21) Appl. No.: 19/549,448

(22) Filed: Feb. 25, 2026

(30) Foreign Application Priority Data
Mar. 3, 2025 (JP) 2025-032644

(51) Int. Cl. H01B 11/18; H01B 11/20

(52) U.S. Cl. CPC H01B 11/1869; H01B 11/20

(57) ABSTRACT

Disclosed is, for example, a multicore cable including: a coaxial wire group composed of a plurality of coaxial wires; and a drain wire disposed along at least one of the coaxial wires; each coaxial wire is constituted by a center conductor; an insulator, which covers the center conductor; and a shield layer, which is provided on the outer circumference of the insulator; and the drain wire contacts the shield layer of the at least one coaxial wire. Each of the coaxial wires may contact the drain wire and also contact the shield layers of the other coaxial wires belonging to the coaxial wire group. The shield layer may be a thin film.

### CROSS REFERENCE TO RELATED APPLICATIONS

This application claims priority to and the benefit of Japanese Application No. 2025-032644, filed March 3, 2025; the content of which is hereby incorporated by reference in its entirety.

### BACKGROUND

### Technical Field

The present disclosure relates to a multicore cable that includes a plurality of electric wires.

### Description of Related Art

Multicore cables constituted by a plurality of electric wires and coaxial wires are conventionally widely used in the fields of communications and data transmission.

There is a demand for multicore cables that support higher speeds and greater capacities in communications or in data transmission, as well as a demand for reducing the diameters of these multicore cables.

In addition, for the multicore cables employed in bending portions, such as in an industrial robot, there is also a demand for bending durability.

One example of the multicore cable used for data transmission is a transmission cable disclosed in Japanese Patent Application Publication Number 2017-10747, which conforms to the USB Type-C standard.

Because a multicore cable that conforms to the USB Type-C standard is required to use coaxial wires, signal lines, power-supply lines, and ground wires according to the USB Type-C standard, there is a technical problem in reducing the diameter of the multicore cable.

Furthermore, when the amount and type of data to be transmitted via the multicore cable increases, a number of corresponding signal lines, coaxial wires, and the like are also needed, and there is a technical problem in that the outer diameter of the multicore cable adversely increases.

In addition, the increase in the outer diameter of the multicore cable is disadvantageous from the viewpoint of the bending durability. Because the flexibility of the multicore cable decreases owing to the outer diameter of the multicore cable becoming larger and the cable weight also increases with the increase in the number of signal lines, coaxial wires, and the like, the load during a bending movement increases and thus becomes one cause of disconnection.

In the situation in which coaxial wires each having a shield layer are used in the multicore cable, even if the center conductor is not necessarily disconnected, the shielding effect decreases when the disconnection occurs at one of the shield layers, thereby having a negative impact on transmission performance.

### BRIEF SUMMARY

An object of an aspect of the present disclosure is to provide a multicore cable that is capable of curtailing an increase in the outer diameter in the situation in which the number of coaxial wires increases, and that excels in bending durability.

As a result of rigorous investigations by the present inventor(s) of structures for multicore cables, the present inventor(s) were able to address the above problems by adopting the following structures.

(1) A multicore cable characterized by including: a coaxial wire group composed of a plurality of coaxial wires; and a drain wire disposed along at least one of the coaxial wires; and characterized in that

each coaxial wire is constituted by a center conductor; an insulator, which covers the center conductor; and a shield layer, which is provided on the outer circumference of the insulator; and

the drain wire contacts the shield layer of the at least one coaxial wire.

(2) The multicore cable according to (1), characterized in that the drain wire contacts the shield layer of each of the plurality of coaxial wires.

(3) The multicore cable according to (1) or (2), characterized in that each of the coaxial wires contacts the drain wire.

(4) The multicore cable according to any of (1)–(3) above, characterized in that each coaxial wire contacts the shield layer of another coaxial wire belonging to the coaxial wire group.

(5) The multicore cable according to any of (1)–(4) above, characterized in that each shield layer is a thin film.

(6) The multicore cable according to (5) above, characterized in that each shield layer is a plating.

(7) The multicore cable according to any of (1)–(6) above, characterized by including a plurality of the coaxial wire groups.

(8) The multicore cable according to (7) above, characterized in that: the plurality of coaxial wire groups is constituted by a first coaxial wire group composed of a plurality of first coaxial wires, and a second coaxial wire group composed of a plurality of second coaxial wires; and

the multicore cable has serving as the drain wire: at least a single first drain wire, which is disposed along at least one of the first coaxial wires and contacts the shield layer of the at least one of first coaxial wires; and

and at least a single second drain wire, which is disposed along at least one of the second coaxial wires and contacts the shield layers of the at least one of second coaxial wires.

(9) The multicore cable according to (8) above, characterized in that the first coaxial wire group and the second coaxial wire group do not contact each other.

(10) The multicore cable according to (8) or (9) above, characterized by further including: an electric wire group including one or a plurality of electric wires, the electric wire group disposed between the first coaxial wire group and the second coaxial wire group.

(11) The multicore cable according to (10) above, characterized in that the first coaxial wire group and the second coaxial wire group are twisted around the electric wire group.

In addition, configurations in which the configurations described in (1)–(11) above are appropriately selected and combined are also within the technical scope of the present disclosure.

### BRIEF DESCRIPTION OF THE DRAWINGS

FIG. 1 is a diagram of a basic configuration of a multicore cable of an aspect of the present disclosure.

FIG. 2 is one example of a first embodiment of the multicore cable of an aspect of the present disclosure.

FIG. 3 is one example of a second embodiment of the multicore cable of an aspect of the present disclosure.

FIG. 4 is one example of a third embodiment of the multicore cable of an aspect of the present disclosure.

FIG. 5 is one example of a fourth embodiment of the multicore cable of an aspect of the present disclosure.

FIG. 6 is a schematic diagram of a bending durability test.

FIG. 7 is a graph showing changes in characteristic impedance in the bending durability tests.

### DETAILED DESCRIPTION OF VARIOUS EMBODIMENTS

A multicore cable 1 of an aspect of the present disclosure is described below with reference to the drawings. Note that the technical scope of the present disclosure is not limited to only the following descriptions or drawings.

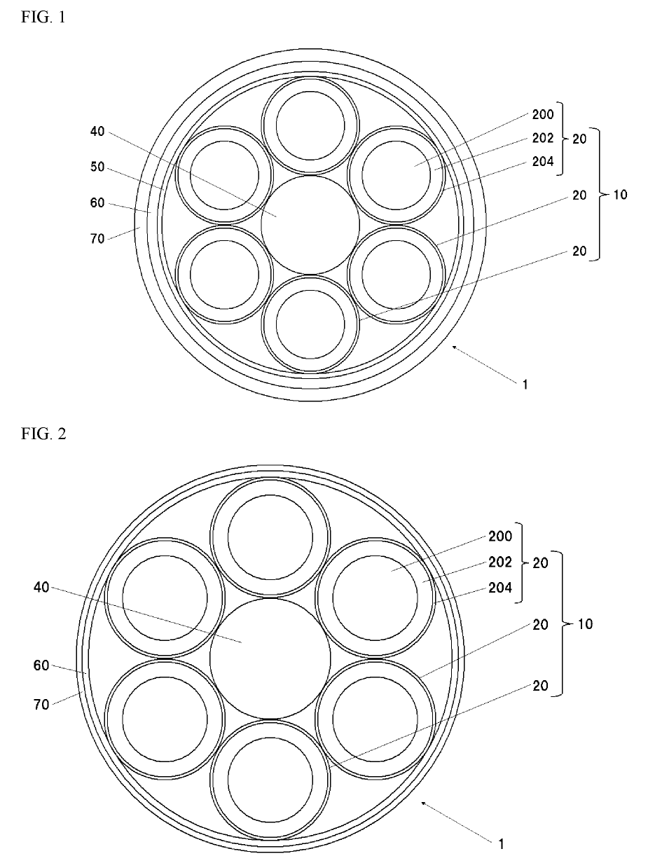

As shown in FIG. 1, the multicore cable 1 of an aspect of the present disclosure includes a coaxial wire group 10 composed of a plurality of coaxial wires 20, and a drain wire 40 disposed along the coaxial wires 20.

The multicore cable 1 of an aspect of the present disclosure also generally comprises: a tape material 50, which is wound in a spiral around an assembled body of the coaxial wire group 10 and the drain wire 40; an overall shield layer 60, which is provided on the outer circumference of the tape component 50; and a tube-shaped sheath 70, which covers the outer circumference of the overall shield layer 60.

The tape material 50 is wound in a spiral shape in the state in which the tape material 50 contacts the assembled body of the coaxial wire group 10 and the drain wire 40; a tape material that is used for a multicore cable, such as woven fabric, paper, or resin can be appropriately selected and used for the tape material 50.

Forms used for the shield layer of a multicore cable, such as a braided shield, a laterally wound shield in which bare metal wire is wound in a spiral, or a metal foil or a resin–metal laminate tape that is wound in a spiral or wound lengthwise, or the like, can be appropriately selected and provided as the overall shield layer 60.

If desired, the overall shield layer 60 and/or the tape material 50 may be omitted.

The sheath 70 is provided to cover the outer circumference of the overall shield layer 60, and resin materials used as the sheath of a multicore cable, such as a fluororesin, polyethylene, or polyvinyl chloride can be appropriately selected and used as the sheath 70.

The wall thickness and outer diameter of the sheath 70 are not particularly limited in the present disclosure; however, from the viewpoint of reducing the diameter of the multicore cable 1, preferably the wall thickness is set to approximately 0.02–0.3 mm, and the outer diameter is set to approximately 0.2–2 mm.

Other than an extrusion coating with a resin material, a resin tape or resin-metal laminate tape that is wound in a spiral or wound lengthwise may serve as the sheath 70.

Each coaxial wire 20 is configured from a center conductor 200, an insulator 202, which covers the center conductor 200, and a shield layer 204 provided on the outer circumference of the insulator 202; the outer circumference of the shield layer 204 is not covered by a coating material, and as such the outermost layer of each coaxial wire 20 is the corresponding shield layer 204. The outer diameter of each coaxial wire 20 is set to approximately 0.05–1 mm.

By having no coating material covering the coaxial wires 20, the coaxial wires 20 are a smaller diameter and a lighter weight compared with coaxial wires that are covered with a coating material; therefore, the coaxial wires 20 contribute to reducing the diameter and reducing the weight of the multicore cable 1, which uses the coaxial wires 20.

The material for a bare conducting wire constituting the center conductor 200 may be appropriately selected from metals or alloys that are known conducting materials and used; specifically, metals, such as copper, silver, or aluminum, or alloys thereof to which tin, iron, zinc, silver, nickel, or the like are added, can be used as the material.

In addition, a surface of the bare conducting wire may be subjected to plating, such as silver, or tin plating.

The configuration of the center conductor 200 is not particularly limited, and the configuration can be appropriately selected from that of single wire, stranded wire, or composite stranded wire, and used. When considering improvements to durability in relation to bending and twisting, a stranded wire or a composite stranded wire can be suitably utilized.

Although the diameter and the conductor cross-sectional area of the center conductor 200 is not particularly limited in the present disclosure, from the view point of making the coaxial wires 20 thin and lightweight, the center conductor 200 having approximately size of 30 to 50 AWG can be suitably utilized.

Materials and configurations known for use as the insulator in a coaxial wire may be used for the insulator 202; for example, fluororesins, such as PFA, FEP, ETFE, or PTFE, and polyolefins, such as polyethylene, or poly (4-methyl-1-pentene) can be used as the insulator 202.

Although the wall thickness of the insulator 202 is not particularly limited in the present disclosure, from the viewpoint of reducing the diameter of the coaxial wire 20, the insulator 202 is preferably formed with a film of approximately 0.01–0.3 mm.

Forms used for the shield layer of a coaxial wire, such as a braided shield, a laterally wound shield in which bare metal wire is wound in a spiral, or a metal foil or a resin–metal laminate tape is wound in a spiral or wound lengthwise, or forming a plating on the insulator 202, can be appropriately selected and used as the form of the shield layer 204.

From the viewpoint of facilitating diameter reduction and weight reduction of the coaxial wires 20, in an aspect of the present disclosure a thin film shield layer, such as a metal foil, a resin–metal laminate tape, a plating, a metal deposition layer, or a conductive ink are desirable for serving as the shield layer 204, and a plating, in particular, is desirable to serve as the shield layer 204.

By having a plating serve as the shield layer 204, the shield layer 204 can be thinly formed compared with other forms, and thus the diameter of the corresponding coaxial wire 20 can be reduced, which also contributes to reducing weight.

In the situation in which a plating serves as the shield layer 204, the thickness thereof can be approximately 0.1–10 μm.

In the situation in which the plating is formed on the insulator 202, a method may be appropriately selected from known methods of forming the plating on a resin material and used to form the layer.

In the situation in which the insulator 202 is a fluororesin, which is a material that is plating-resistant, the molecular bonding agent disclosed in Japanese Patent Application Publication Number 2009-170113, or the modified layer disclosed in Japanese Patent Application Publication Number 2020-82443 may be appropriately selected from among methods intended for metal deposition on fluororesins, and utilized.

Copper, nickel, gold, silver, tin, and the like, which have excellent conductivity, are examples of candidate metals used for plating.

The drain wire 40 is disposed along at least one of the coaxial wires 20 that constitutes the coaxial wire group 10, and is in contact with the shield layer 204 of that at least one coaxial wire 20.

This configuration places the shield layer 204 and the drain wire 40 in a state of electrical contact, and thus contributes to improving the bending durability of the multicore cable 1 by the drain wire 40 functioning as an alternate route for electrical current flowing in the shield layer 204.

In the situation in which the plating, in particular, serves as the shield layer 204, if cracking occurs in the plating when the multicore cable bends, the crack will disrupt the flow of electric current through the shield layer 204; however, by the drain wire 40 being an alternate route for the electric current flowing in the shield layer 204, the effect due to the crack is curtailed, and the drain wire 40 thus contributes to improving the bending durability of the multicore cable 1.

The method of contact between the coaxial wires 20 and the drain wire 40 may be contact from a parallel arrangement or contact from twisting. The multicore cable 1 shown in FIG. 1 is a multicore cable in which the coaxial wire 20 is twisted around the outer circumference of the drain wire 40.

The drain wire 40 is preferably disposed so as to contact the shield layers 204 of the plurality of coaxial wires 20. By the drain wire 40 contacting the plurality of coaxial wires 20, the effect owing to the drain wire 40 described above can be obtained for the plurality of coaxial wires 20.

In addition, the drain wire 40 is preferably arranged so that the drain wire 40 contacts each of the shield layers 204 of the plurality of coaxial wires 20. By each of the coaxial wires 20 contacting the drain wire 40, the effect from the drain wire 40 described above can be obtained for the coaxial wires 20.

In addition, the shield layer 204 of one coaxial wire 20 is preferably arranged so that it contacts the shield layers 204 of the other coaxial wires 20 in the coaxial wire group 10.

By adopting this configuration, the effect achieved by contact between the coaxial wires 20 and the drain wire 40 can be expected between mutually contacting coaxial wires 20, and thus contributes to improving the bending durability of the multicore cable 1.

The drain wire 40 can be constituted by a single wire that is used as a single bare drain wire, or by a stranded wire in which a plurality of bare drain wires are stranded; from the viewpoint of bending durability, the stranded wire can be suitably utilized as the drain wire 40.

The outer diameter of the drain wire 40 is set to approximately 0.03–0.3 mm, and is generally less than or equal to the outer diameter of the coaxial wires 20.

The material for a bare drain wire may be appropriately selected from metals or alloys that are known conducting materials and used; specifically, metals, such as copper, silver, or aluminum, or alloys thereof to which tin, iron, zinc, silver, nickel, or the like are added, can be used as the material; the bare drain wire may be subjected to plating, such as silver plating or tin plating.

### First Embodiment

The multicore cable 1 according to a first embodiment is shown in FIG. 2.

The multicore cable 1 according to the first embodiment is configured by twisting six strands of the coaxial wires 20 around the drain wire 40, which is constituted by stranding seven strands of tin-plated soft copper wire each having an outer diameter of 0.16 mm.

Each coaxial wire 20 is configured by covering the center conductor 200, which is constituted by stranding seven strands of silver-plated soft copper wire, each having an outer diameter of 0.05 mm, with the insulator 202, which is PFA of thickness 0.15 mm, and forming a copper plating that is 3 μm thick on the outer circumference thereof to serve as the shield layer 204.

A multicore cable 1-1 according to the first embodiment is configured by winding a resin-metal laminate tape—the thickness of the metal layer being 8 μm, and the thickness of the resin layer being 4 μm—around an assembled body in which the coaxial wires 20 are twisted around the drain wire 40 in a spiral such that the resin layer of the tape is outward.

The resin layer of the resin-metal laminate tape is PET, and the metal layer is formed from copper; the resin layer and the metal layer correspond to the sheath 70 and the overall shield layer 60, respectively.

### Second Embodiment

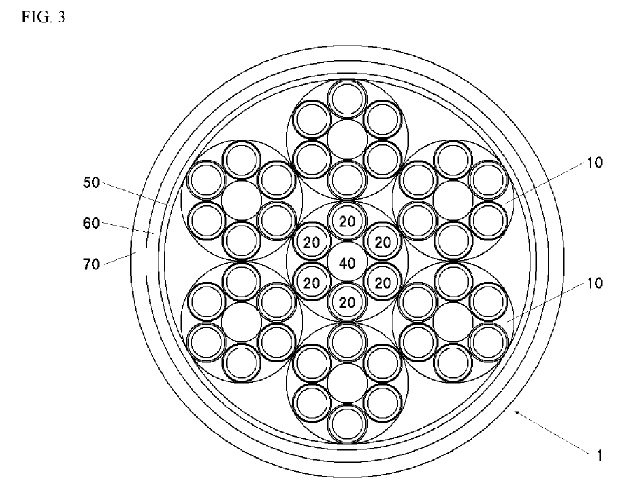

The coaxial wire group 10 constituting the multicore cable 1 of the present disclosure is not limited to only one group, and the multicore cable 1 may be constituted by a plurality of coaxial wire groups 10. FIG. 3 shows a multicore cable constituted by the seven coaxial wire groups 10 as the multicore cable 1 according to a second embodiment.

The multicore cable 1 according to the second embodiment includes: an assembled body in which seven of the multicore cables according to the first embodiment above are twisted. The multicore cable 1 is constituted by: the tape material 50, which is wound around the assembled body in a spiral; the overall shield layer 60, which is provided on the outer circumference of the tape material 50; and the tube-shaped sheath 70, which covers the outer circumference of the overall shield layer 60.

When constituting the multicore cable 1 with the plurality of coaxial wire groups 10, each of the drain wires 40 is disposed along at least one of the coaxial wires 20 belonging to the corresponding coaxial wire group 10.

The multicore cable 1 depicted in FIG. 3 shows the situation in which the form of the coaxial wires 20 belonging to each of the coaxial wire groups 10 is identical; however, the form of the coaxial wires 20 may differ according to the coaxial wire group 10, if desired.

### Third Embodiment

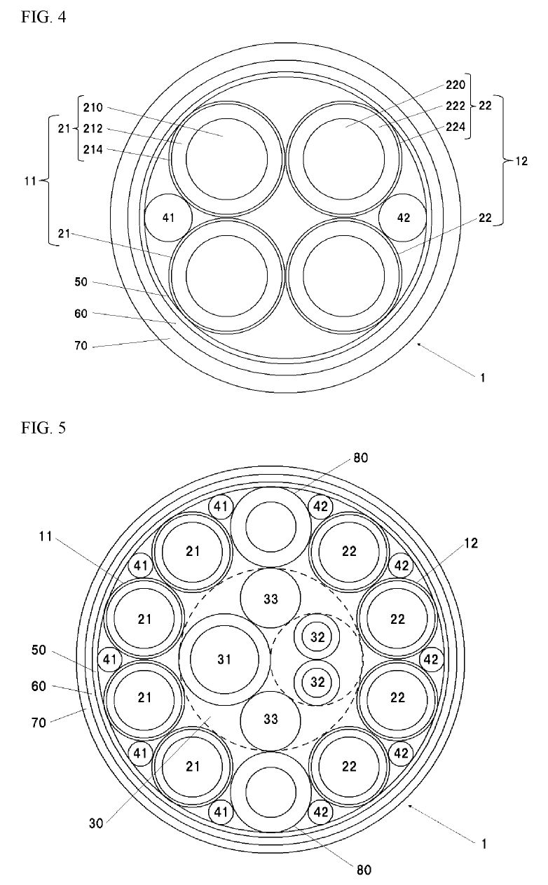

FIG. 4 shows another example of the multicore cable 1 constituted by a plurality of coaxial wire groups 10 as the multicore cable 1 according to a third embodiment.

The multicore cable 1 of FIG. 4 comprises: a first coaxial wire group 11 and a second coaxial wire group 12; the multicore cable 1 is constituted by the tape material 50, which is wound in a spiral around the assembled body of the coaxial wire groups; the overall shield layer 60, which is provided on the outer circumference of the tape material 50; and the tube-shaped sheath 70, which covers the outer circumference of the overall shield layer 60.

The multicore cable 1 of FIG. 4 houses the first coaxial wire group 11 and the second coaxial wire group 12, and a first drain wire 41 and a second drain wire 42 inside the sheath 70.

The first drain wire 41 is disposed along at least one of the first coaxial wires 21 that constitute the first coaxial wire group 11, and contacts the shield layer 214 of that one first coaxial wire 21.

Each of the first coaxial wires 21 that constitute the first coaxial wire group 11 is preferably disposed to contact at least one of the first drain wires 41.

Similar to the first drain wire 41, the second drain wire 42 is disposed along at least one of the second coaxial wires 22 that constitute the second coaxial wire group 12, and contacts the shield layer 214 of that one second coaxial wire 22.

Each of the second coaxial wires 22 that constitute the second coaxial wire group 12 is also preferably disposed to contact at least one of the second drain wires 42.

The shield layer 214 of one first coaxial wire 21 preferably contacts the shield layer 214 of the other first coaxial wire 21 belonging to the first coaxial wire group 11.

Similarly, the shield layer 224 of one second coaxial wire 22 preferably contacts the shield layer 224 of the other second coaxial wire 22 belonging to the second coaxial wire group 12.

The first coaxial wire group 11 and the second coaxial wire group 12 may be disposed to have no contact, if desired. In this aspect, signal interference between coaxial wire groups can be curtailed, thus contributing to improving the transmission characteristics of the multicore cable 1.

### Fourth Embodiment

Besides the coaxial wire group 10, and the drain wire 40, an electric wire, or the like may also be added to the multicore cable 1 of an aspect of the present disclosure. FIG. 5 shows a configuration in which an electric wire group 30, which is constituted by one or a plurality of electric wires, is disposed between the first coaxial wire group 11 and the second coaxial wire group 12 as the multicore cable 1 according to a fourth embodiment.

For example, in the situation in which the multicore cable 1 is to conform to the USB Type-C standard, as shown in FIG. 5, a power-supply line 31, stranded-pair wire 32, and a ground wire 33 may be twisted together and used as the electric wire group 30.

The configuration of the electric wire group 30 shown in FIG. 5 is one example, and a specific configuration of the electric wire group 30 can be modified, as appropriate, in accordance with the application of the multicore cable 1.

When disposing the electric wire group 30, the multicore cable 1 may be configured by twisting the first coaxial wire group 11 and the second coaxial wire group 12 around the electric wire group 30 as shown in FIG. 5.

When disposing the electric wire group 30, the first coaxial wire group 11 and the second coaxial wire group 12 can be configured to not contact each other; therefore, curtailment of signal interference between the coaxial wire groups can be expected.

When disposing the electric wire group 30, in the situation in which the configuration is to reliably ensured that the first coaxial wire group 11 and the second coaxial wire group 12 do not contact each other, the multicore cable 1 may be configured by disposing an insulated electric wire, a coaxial wire, an interposing wire, or the like that becomes a spacer 80 between the adjacent first coaxial wire group 11 and second coaxial wire group 12 as shown in FIG. 5.

A signal line, control line, power-supply line, ground wire, or the like can be used as desired as the insulated electric wire, or coaxial wire disposed to serve as the spacer 80. FIG. 5 shows the situation in which the insulated electric wire, which is presumed to be used as the power-supply line is disposed as the spacer 80.

While a basic configuration and embodiments of the multicore cable 1 of an aspect of the present disclosure are explained above, the specific form of the present disclosure is not limited thereto and the forms thereof can be modified as appropriate and put into practice within the scope of technical concepts of the present disclosure.

Besides the transmission cable that conforms to the USB Type-C standard, the multicore cable 1 of an aspect of the present disclosure can be used as the imaging cable that connects to an imaging element such as a CMOS sensor, an ultrasound cable used in an ultrasonic inspection device configured with an ultrasonic probe, or the like, or a wiring cable for a compact information machine, and can be in a form that uses a total of several to several hundred coaxial wires 20.

Even in the situation in which the number of coaxial wires 20 used increases, weight reduction and diameter reduction of the multicore cable 1 can be facilitated by using the configurations of the present disclosure. The greater the number of coaxial wires 20 the more noticeable the effects of the weight reduction and the diameter reduction owing to the present disclosure.

Specific values for the diameter reducing effects differ depending on the form of the multicore cable 1; however, the outer diameter of the multicore cable 1 of the present disclosure can be made thinner by approximately 10–30% and in some situations can be made 30% thinner or more compared with the situation in which the coaxial wires are covered with a coating material.

### Working Example

### Working Example 1

The multicore cable 1 of the first embodiment described above was taken as Working Example 1.

### Comparative Example 1

A multicore cable 1' of Comparative Example 1 was produced by replacing the drain wire 40 in the multicore cable 1 of Working Example 1 with a coaxial wire 20.

The following test was conducted on multicore cables of the Working Example and the Comparative Example, respectively.

### Bending Durability Test

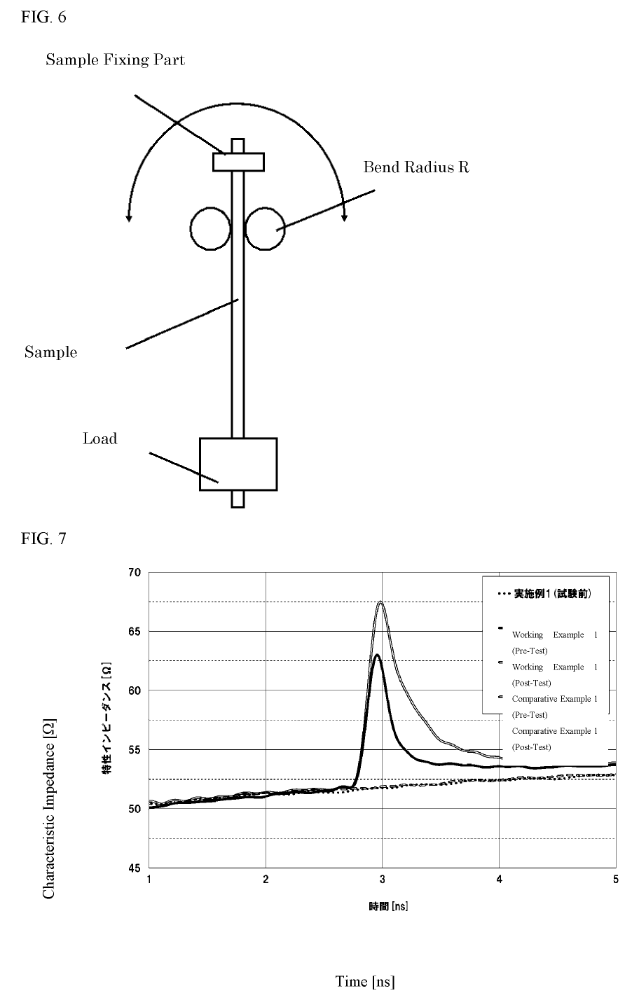

The bending durability of the multicore cable 1 was evaluated using the bending durability test apparatus shown in FIG. 6. Each of the multicore cables was cut to a length of 1000 mm, and each sample, with a load of 250 g attached, was lightly sandwiched between mandrels of R 7.5 mm; testing was performed by bending the sample to the left and then to the right at 90° each time, at a speed of 30 operations/minute, where bending the sample to the left and to the right at 90° each time was taken as one bending operation. The characteristic impedances of the samples were measured after 10,000 bending operations, and these characteristic impedances were compared to those prior to bending.

FIG. 7 shows the characteristic impedance of the working example and the comparative example respectively, before and after the bending durability tests. The characteristic impedance measurements were taken by employing the TDR method.

The pre-test characteristic impedances of Working Example 1 and Comparative Example 1 were both approximately 50 Ω, which is a value indicated by a typical coaxial cable.

The post-test characteristic impedance of Comparative Example 1 rose up to approximately 67.5 Ω near 3 ns, which corresponds to the bending location; and it can be deduced then that cracking occurred in the shield layers 204 of the coaxial wires 20 constituting the multicore cable 1' owing to the bending, and a disturbance occurred in the characteristic impedance because the state of the electrical current changed in the corresponding shield layer 204.

In contrast, although a rise in the characteristic impedance occurs near 3 ns in post-test Working Example 1, the rise stops at approximately 63 Ω, and the rise time is reduced compared to Comparative Example 1. Thus, the evaluation is that by adopting an aspect of the present disclosure, even when cracking occurs in the shield layers 204 of the coaxial wires 20 that constitute the multicore cable 1, the presence of the drain wire 40 curtails changes in the state of electric current in the shield layers 204, and curtails disturbances in the characteristic impedance.

What is claimed is:

1. A multicore cable comprising:
a coaxial wire group comprising a plurality of coaxial wires; and
a drain wire disposed along at least one of the coaxial wires, wherein,
each coaxial wire comprises a conductor, an insulator covering the conductor, and a shield layer on the outer circumference of the insulator, and
the drain wire contacts the shield layer of at least one of the coaxial wires.

2. The multicore cable according to claim 1, wherein the drain wire contacts the shield layer of at least two of the plurality of coaxial wires.

3. The multicore cable according to claim 2, wherein each of the coaxial wires contacts the shield layer of another coaxial wire of the same coaxial wire group.

4. The multicore cable according to claim 1, wherein each of the coaxial wires contacts the drain wire.

5. The multicore cable according to claim 4, wherein each of the coaxial wires contacts the shield layer of another coaxial wire of the same coaxial wire group.

6. The multicore cable according to claim 1, wherein the shield layer is a thin film.

7. The multicore cable according to claim 6, wherein the shield layer is a plating.

8. The multicore cable according to claim 1, comprising a plurality of coaxial wire groups.

9. The multicore cable according to claim 8, wherein:
the plurality of coaxial wire groups comprises a first coaxial wire group comprising a plurality of first coaxial wires, and a second coaxial wire group comprising a plurality of second coaxial wires,
a first drain wire disposed along at least one of the first coaxial wires and contacts the shield layer of the at least one of first coaxial wires, and
a second drain wire disposed along at least one of the second coaxial wires and contacts the shield layers of the at least one of second coaxial wires.

10. The multicore cable according to claim 9, wherein the first coaxial wire group and the second coaxial wire group do not contact each other.

11. The multicore cable according to claim 10, further comprising: an electric wire group comprising one or a plurality of electric wires, the electric wire group disposed between the first coaxial wire group and the second coaxial wire group.

12. The multicore cable according to claim 11, wherein the first coaxial wire group and the second coaxial wire group are twisted around the electric wire group.
